(19) United States
(12) Patent Application Publication
(10) Pub. No.: US 2025/0284968 A1
(43) Pub. Date: Sep. 11, 2025

(54) Method for Generating a Training Dataset

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Kakit Law, Reutlingen (DE); Lukas Fiederer, Balingen (DE); Tal Dekel, Ramat Gan (IL); Uwe Troeltzsch, Roesrath (DE)

(21) Appl. No.: 19/074,350

(22) Filed: Mar. 8, 2025

(30) Foreign Application Priority Data
Mar. 11, 2024 (DE) 10 2024 202 245.4

(51) Int. Cl. G06N 3/09; G06N 3/0475

(52) U.S. Cl. CPC G06N 3/09; G06N 3/0475

(57) ABSTRACT

A computer-implemented method for generating a training dataset for training an artificial intelligence for operating a measuring device, in particular a wall diagnostic device, includes (i) receiving unclassified sensor data of at least one sensor unit of a measuring device by a classifier module, (ii) classifying the unclassified sensor data and providing classified sensor data using a classifier module, and (iii) adding the classified sensor data to a training dataset.

This application claims priority under 35 U.S.C. § 119 to application no. DE 10 2024 202 245.4, filed on Mar. 11, 2024 in Germany, the disclosure of which is incorporated herein by reference in its entirety.

The present disclosure relates to a method for generating a training dataset for training an artificial intelligence for a wall diagnostic device.

### BACKGROUND

Diagnostic devices for performing wall diagnostics and detecting objects formed in the walls are known from prior art.

It is a task of the present disclosure to provide an improved method for generating a training dataset for training an artificial intelligence of a wall diagnostic device.

The task is solved by the method set forth below. Advantageous embodiments are subject-matter also set forth below.

### SUMMARY

According to one aspect, a computer-implemented method is provided for generating a training dataset for training an artificial intelligence to operate a measuring device, in particular a wall diagnostic device, wherein the method comprises:
receiving unclassified sensor data of at least one sensor unit of a measuring device via a classifier module, wherein the sensor data depicts a wall to be diagnosed having a wall type, and wherein an object of an object type is disposed in the wall in an object position;
classifying the unclassified sensor data and providing classified sensor data via a classifier module, wherein the classifier module is configured as an artificial intelligence and trained via semi-supervised learning to determine a classification for the unclassified sensor data with respect to the wall type and/or object position and/or object type of the object; and adding the classified sensor data to a training dataset.

This may achieve the technical advantage of providing an improved method for generating a training dataset for training an artificial intelligence to operate a measuring device, in particular a wall diagnostic device. For this purpose, initially unclassified sensor data of at least one sensor unit of a measuring device is received by a classifier module. The sensor data depicts a wall of a wall type to be examined and objects disposed in the wall. The unclassified sensor data is classified via the classifier module and converted into correspondingly classified sensor data.

The classifier module is configured as an artificial intelligence trained via a semi-supervised learning process to find a corresponding classification for unclassified sensor data. The classification is thereby carried out in relation to the wall type and/or the object position and/or the object type of the objects disposed in the wall. The sensor data correspondingly classified by the classifier module, is subsequently added to the training dataset to be generated.

By using a correspondingly trained artificial intelligence as a classifier module, precise and reliable classification of unclassified sensor data can be carried out. The classified sensor data is labeled with respect to the classification. The classification states which object is positioned or present in the wall type of the wall depicted by the sensor data, or in which object position the object is disposed or states the object type of an object disposed in the wall.

Classified sensor data corresponds to the labeled sensor data known from the prior art of machine learning. The unclassified sensor data corresponds to the unlabeled sensor data known from the prior art. The classification of the classified sensor data thus corresponds to a labeling of the sensor data with respect to the particular classification feature.

According to one embodiment, the classifier module was trained on classified sensor data and sensor data with pseudo-classifications, in order to determine corresponding classifications for unclassified sensor data, wherein the pseudo-classifications were predicted by a pseudo-classification module based on unclassified sensor data, and wherein the pseudo-classification module is configured as an artificial intelligence and is trained on classified sensor data to determine pseudo-classifications for unclassified sensor data.

This may achieve the technical advantage that an improved classifier module may be provided to classify unclassified sensor data. The classifier module is trained on a training dataset comprising classified sensor data and sensor data with a pseudo-classification. The sensor data with a pseudo-classification was in turn classified by a pseudo-classification module. The pseudo-classification module, in turn, is trained on classified sensor data to determine pseudo-classifications for unclassified sensor data. The pseudo-classifications are classifications of the sensor data with respect to the classification characteristics mentioned above that were generated by the pseudo-classification module.

The classified sensor data, on the other hand, is not automatically classified, but rather has been manually classified as is common in the prior art in the field of machine learning. The sensor data may be based on measurements from measuring devices carried out on real walls of buildings. Alternatively or additionally, the sensor data may be based on measurements of laboratory walls.

The laboratory walls have the advantage that all features of the wall or the objects disposed in the walls are known to the experimenter. This may result in a more precise manual classification of the sensor data recorded accordingly. By using classified sensor data and sensor data with a pseudo-classification to train the classifier module, better training of the classifier module may be achieved than would be possible based only on classified sensor data. This may improve the performance of the correspondingly trained classifier module.

According to one embodiment, the classifier module is configured as a convolutional network.

This may achieve the technical advantage of providing a powerful classifier module.

According to one embodiment, classification comprises:
generating latent space representations of the unclassified sensor data in a latent space using the classifier module, wherein latent space representations of sensor data are configured as dimension-reduced representations of the sensor data;
determining distances between latent space representations of the unclassified sensor data and latent space representations of classified sensor data in the latent space using a distance determination module;
classifying the unclassified sensor data with respect to the wall type of the wall and/or the object position and/or the object type of the object based on the distances between the latent space representations of the unclassified sensor data and the latent space representations of the classified sensor data in the latent space, wherein the unclassified sensor data is classified according to a classification of the classified sensor data, if the distances between the latent space representations of the unclassified sensor data and the latent space representations of the classified sensor data in the latent space are less than or equal to a predefined threshold value.

This may achieve the technical advantage of enabling precise classification of the unclassified sensor data by the classifier module. For this purpose, latent space representations in a latent space are initially generated by the classifier module based on the unclassified sensor data. The latent space representations herein represent dimension-reduced representations of the sensor data. The latent space representations may be configured as vector representations, as is known in the prior art. The latent space representations may in particular be interpreted as dimension-reduced encodings of the information of the sensor data. Further, distances between the latent space representations determined for the unclassified sensor data and latent space representations of already classified sensor data in the latent space are determined by a distance determination module. Based on the determined distances, classification of the unclassified sensor data may subsequently be carried out. Thus, the unclassified sensor data is classified according to classified sensor data, i.e. assigned to the same class of objects as the classified sensor data, if the distances between the latent space representations of the unclassified sensor data and the latent space representations of the classified sensor data are less than or equal to a predefined threshold value. Classification via distance determination for the latent space representations in the latent space is a precise and reliable method of classifying unclassified sensor data.

The respective classification or the corresponding object class of the classified sensor data may be considered as an additional entry in the vector representations of the respective latent space representations. Classification by latent space representations is based on the idea that sensor data of the same classification comprises latent space representations with the same or at least very similar vector representations. Such latent space representations have correspondingly small distances from one another in latent space. Classification of unclassified sensor data is thus possible via the distance determination and by selecting a suitable threshold value for the distance.

According to one embodiment, the distances are defined as Euclidean distances.

This can achieve the technical advantage of enabling a simple distance determination.

According to one embodiment, classification comprises:
generating latent space representations of the unclassified sensor data in a latent space using the classifier module, wherein latent space representations of sensor data are configured as dimension-reduced representations of the sensor data;
classifying the unclassified sensor data with respect to the wall type of the wall and/or the object position and/or the object type of the object based on the latent space representations of the unclassified sensor data using a classifier module, wherein the classifier module is configured as an artificial intelligence and trained on latent space representations of classified sensor data to determine a classification of the respective sensor data.

This may achieve the technical advantage of enabling a precise classification of the unclassified sensor data based on the latent space representations of the unclassified sensor data.

According to one embodiment, the classifier module is configured as a Generative Adversarial Network GAN, particularly as an autoencoder having an encoder module and a decoder module.

This may achieve the technical advantage of providing a powerful and reliable classifier module.

According to one embodiment, the sensor data comprises radar data of a radar sensor and/or data of an induction sensor and/or an eddy current sensor and/or a capacitance sensor and/or an alternating current sensor and/or an NMR sensor and/or an ultrasonic sensor.

This may achieve the technical advantage that a wide range of different physical metrics can be considered via the different sensor types. This enables the generation of a comprehensive training dataset. Further, this allows for comprehensive training of the artificial intelligence that can be trained to take into account the various physical metrics and the information based on these relating to the wall and the objects disposed therein in the wall diagnosis.

According to one embodiment, the classification of the sensor data is further performed with respect to an object depth and/or an object extent of the object.

This may achieve the technical advantage that additional information regarding the properties of the objects disposed in the wall can be incorporated into the training and wall diagnostics. This may improve the wall diagnostics of the diagnostic module.

According to one embodiment, object classes of the object type of the object comprise: Metal/non-metal object, low voltage cable, single phase AC signal cable, multi phase AC signal cable, wood beam, metal beam, plastic pipe, water filled plastic pipe, for example fresh water pipe, non-water filled plastic pipe, for example waste water pipe, and/or wherein the wall type classes of the wall type of the wall comprise: Concrete wall, plasterboard/drywall wall, brick wall and/or bricks of the wall, floor heating, wall heating.

The technical advantage may thereby be achieved that a large number of different objects of different object types can be detected or classified. The measuring device or the diagnostic module can be trained hereby to detect and classify common objects installed in building walls. This allows particularly precise wall diagnostics, in which the detected objects can be precisely and unambiguously assigned to the corresponding object classes.

By precisely classifying objects and providing the corresponding classification information to the user via the display unit, wall diagnostics are made as meaningful as possible. Since the user not only knows that an object is located within the wall and where it is, but also which object type the detected object is, the user can decide accordingly how to carry out further work on the wall with respect to the detected object. Providing the object types of the object classification of the detected objects thus represents an essential area of the wall diagnostics, because the user can adjust the planned work on the wall based on the indicated object type accordingly.

According to one aspect, a training dataset for training an artificial intelligence of a wall diagnostic measuring device is provided, wherein the training dataset was generated by the method for generating a training dataset for training an artificial intelligence for operating a measuring device according to one of the preceding embodiments.

Provided according to one aspect is a computing unit configured to perform the method of generating a training dataset for training an artificial intelligence for operating a measuring device according to one of the preceding embodiments.

Provided according one aspect is a computer program product comprising instructions that, when the program is executed by a data processing unit, cause the latter to perform the method for generating a training dataset to train an artificial intelligence to operate a measuring device according to one of the preceding embodiments.

### BRIEF DESCRIPTION OF THE DRAWINGS

Embodiments of the disclosure are described with reference to the following figures. The figures show:

FIG. 1 a schematic representation of a measuring device according to one embodiment;

FIG. 2 a further schematic representation of the measuring device according to a further embodiment;

FIG. 3 a further schematic representation of the measuring device according to a further embodiment;

FIG. 4 a schematic representation of a measurement of the measuring device according to one embodiment,

FIG. 5 a further schematic representation of the measuring device according to a further embodiment;

FIG. 6 a schematic representation of a system for generating a training dataset according to one embodiment,

FIG. 7 a further schematic representation of a system for generating a training dataset according to a further embodiment,

FIG. 8 a further schematic representation of the system for generating a training dataset according to a further embodiment,

FIG. 9 a further schematic representation of the system for generating a training dataset according to a further embodiment,

FIG. 10 a flowchart of a method for generating a training dataset according to one embodiment,

FIG. 11 a further flowchart of the method for generating a training dataset according to a further embodiment,

FIG. 12 a further flowchart of the method for generating a training dataset according to a further embodiment, and

FIG. 13 a schematic representation of a computer program product.

### DETAILED DESCRIPTION

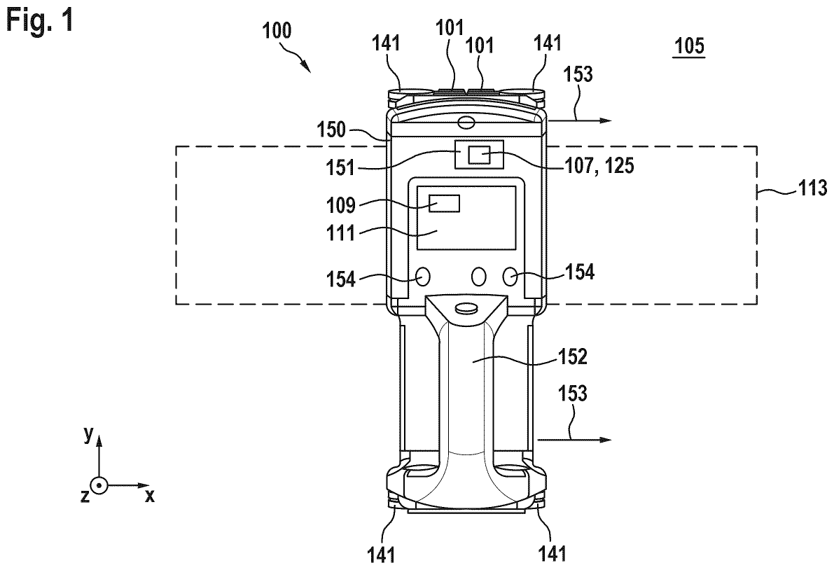

FIG. 1 shows a schematic representation of a measuring device 100 according to one embodiment.

The present disclosure relates to a measuring device, in particular a wall diagnostic device for examining walls 105 to be worked on. Wall diagnostic devices are known from the prior art that are used to detect objects located in walls. Such devices allow a user to examine walls to be worked on to search for objects located in the walls, in order to be able to perform planned work, for example drilling in walls, such that damage to the objects located in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 between various operating modes.

According to the disclosure, the measuring device 100 comprises at least one radar sensor unit 101. By way of the radar sensor unit 101, radar signals may be transmitted towards the wall 105 to be examined, and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform corresponding diagnostics on the wall to be examined based on the radar data 103 of the radar sensor unit 101. The radar data 103 of the radar sensor unit 101 thereby depicts the wall 105 to be examined and, if applicable, objects 113 located within the wall 105.

The wall diagnostics carried out by the diagnostic module 107 comprise at least performing object recognition. The object recognition comprises an object detection and an object classification of the object 113 located in the wall 105. The object detection comprises at least the determination of an object position 115. The object position describes the positioning of the object located in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 located in the wall 105, are subsequently presented in a display unit 111 of the measuring device 100 to a user of the measuring device 100. For example, the display unit 111 may be configured as a corresponding display, and the diagnostic results 109 may be visually displayed. Additionally, the display of the diagnostic results 109 may be supported via audible and/or haptic signals. For example, the haptic signals may be realized via corresponding vibration signals.

The object 113 may be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105, and radar signals reflected from the wall 105 or the objects 113 located behind it are received, via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 located in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-mentioned wall diagnostics based on the radar data 103 of the radar sensor unit 101 and to determine at least the object position 115 and the object type 117 of an object 113 located in the wall 105. The object classification or determination of the object type 117, respectively, comprises assigning the detected object 113 to predefined object classes.

The object classes may comprise: Metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, or other elements commonly installed in building walls.

Furthermore, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can particularly be used for object recognition of the objects 113 located in the walls 105. The additional sensor information may possibly provide improved detection of the objects 113 and may possibly provide improved classification of the objects 113.

For example, the material of the objects 113, for example as a metallic or non-metallic material, can be particularly improved and classified by using the additional sensor information.

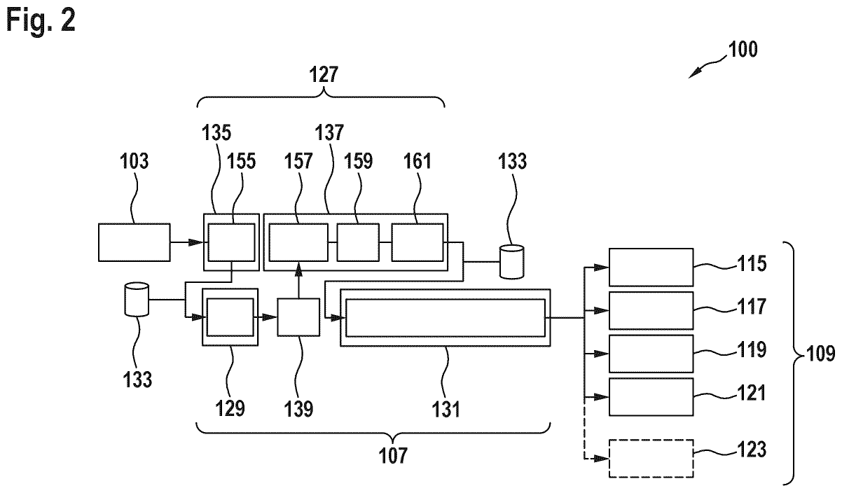

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing by the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be considered during the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. During the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects can occur on the radar data 103.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 131 performs object recognition of the object 113 located in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

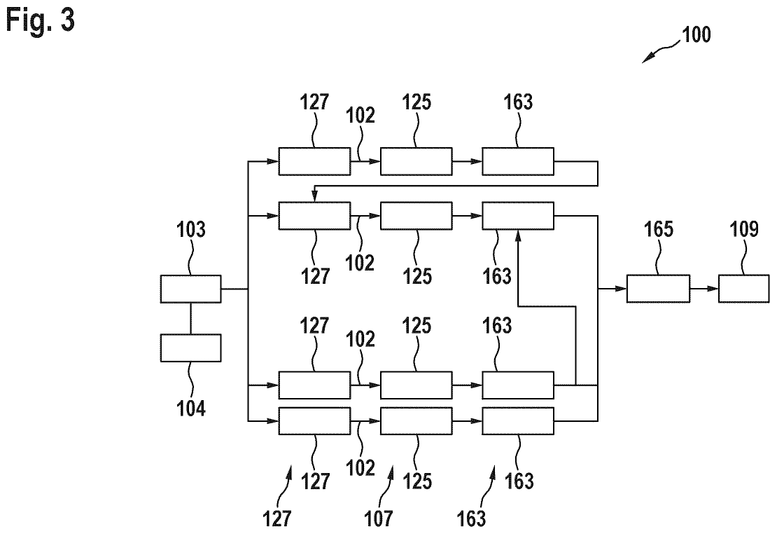

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, comprising the wall type classification module 129 and/or the object recognition module 131, for example, according to the embodiment in FIG. 2, and a post-processing module 163.

In FIG. 3, primarily the radar data 103 is shown as input data for the wall diagnostics. In addition to the radar data shown, however, the additional information from the additional sensors may also serve as input data for the wall diagnostics. The different information from the different types of sensors in the different parallel processing paths 102 can be processed and the corresponding wall diagnostics performed separately on the different sensor information. Upon completion of the wall diagnostics, a summary module may be used to assemble a summary of the individual partial analysis results for the diagnostic results 109 of the wall diagnostics.

Alternatively or additionally, different sub-aspects of wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moves relative to the wall 105, may then be processed in the different processing paths 102 by the modules shown.

The various processing paths perform stand-alone wall diagnostics including at least determining the object position 115 and/or the object type 117 of the object 113 located in the wall 105.

By way of the summary module 165, the partial results of the stand-alone wall diagnostics of the different regions of the wall 105 provided in the individual processing paths 102 can be summarized to a contiguous diagnostic result 109. The contiguous diagnostic result describes the wall diagnostics of a contiguous spatial area that was scanned during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object 113 located in the wall can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may each be carried out. In the summary module 165, the various partial results of the wall diagnostics may be summarized into corresponding diagnostic results 109.

The diagnostic module 107 can be divided into different artificial intelligence structures 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligence structures 125, for example, neural networks. Alternatively, the various modules may form portions of an overall artificial neural network that are connected to an overall neural network according to structures known from prior art.

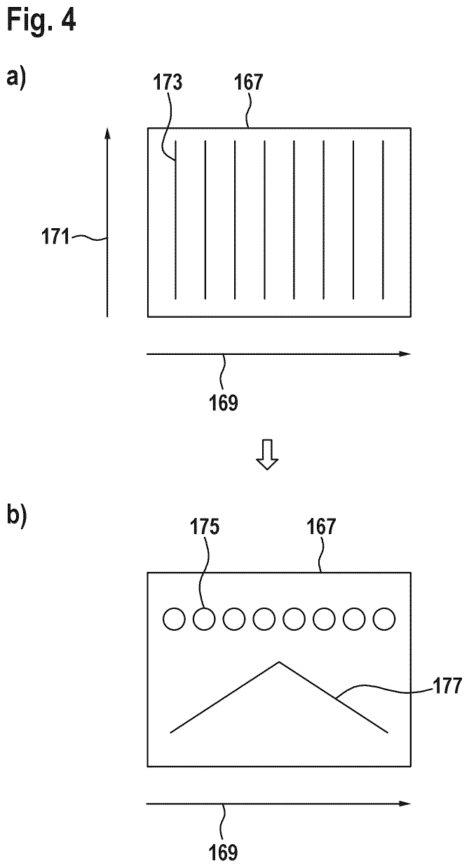

FIG. 4 shows a schematic illustration of a measurement by the measuring device 100 according to one embodiment.

For pre-processing, the radar data 103 or the additional sensor information 104 of the remaining sensors may be normalized, in particular to numerically stabilize the subsequent steps performed by the diagnostic module 107 during the wall diagnostics. For example, an amplitude and/or offset compensation may be performed for this purpose. Moreover, to reduce interference, filtering of the radar data 103 may be carried out, and to reduce the data rate, the corresponding sensor data may be sampled. Additionally, the radar data 103 or the additional sensor information 104 may be transformed into the respectively required frequency range or time range. Methods known from the prior art can be used for this purpose.

Furthermore, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement by the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more sampling points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data can comprise the respective pre-processed sensor data, i.e. radar data 103 and additional sensor information 104 of the additional sensors.

As stated above, the wall diagnostics may be performed by the diagnostic module 107 based on a correspondingly trained artificial intelligence. Alternatively, different processing paths may also be calculated by way of rule-based algorithms. In addition, within a processing path 102, a combination of artificial intelligence and rule-based algorithm is possible in the form of a parallel operation or concatenation.

The diagnostic results 109 of the wall diagnostics may be expressed as numeric values, vectors, or matrices. Furthermore, for the object detection, the probability of detection, or for the wall type classification and/or the object classification, respectively, a probability of the specified object classes and/or wall type classifications can be indicated. The same may apply to the position and/or depth determination, for which corresponding probability values can also be indicated.

In addition to the radar data 103, if the additional sensor information of the further sensor types is processed in a processing path 102, these may either be merged within the artificial intelligence 125 or combined by way of rule-based combinations.

During the post-processing of each processing path 102, of the embodiment in FIG. 3, multiple algorithm results based on multiple windows 167 may be summarized by the summary module 165. This summary can in particular be realized by way of majority formation, sum formation or also by multiplication of successive probability values.

Furthermore, by clustering multiple results, for example, it is possible to detect which objects, of multiple detected objects located close to one another, are the same object so that they are not incorrectly detected multiple times.

Likewise, it is possible to multiplicatively apply a weighting function 177 when summarizing the results from multiple windows 167. Advantageously, the diagnostic partial results 175 corresponding to corresponding data points in the space may be weighted with respect to positioning of the diagnostic partial results 175 relative to a center point of the respective window 167. This is illustrated by way of example in graph b), in which the individual diagnostic partial results 175 are weighted according to the weighting function 177 shown with respect to the center point of the window 167 shown.

According to one embodiment, the results of one processing path 102 after post-processing 163 may influence the extension of another processing path 102. Weighting parameters may be adjusted that may depend on the particular result from the processing path 102 for each window.

For example, the result of an object classification in which the object type 117 of an object located in the wall 105 is defined, can be used to increase the weight of a wall type classification, in which the wall type 123 of the respective wall 105 is determined, during the post-processing at locations without objects 113, because the respective radar data 103 at these locations is less influenced by reflections of the objects 113.

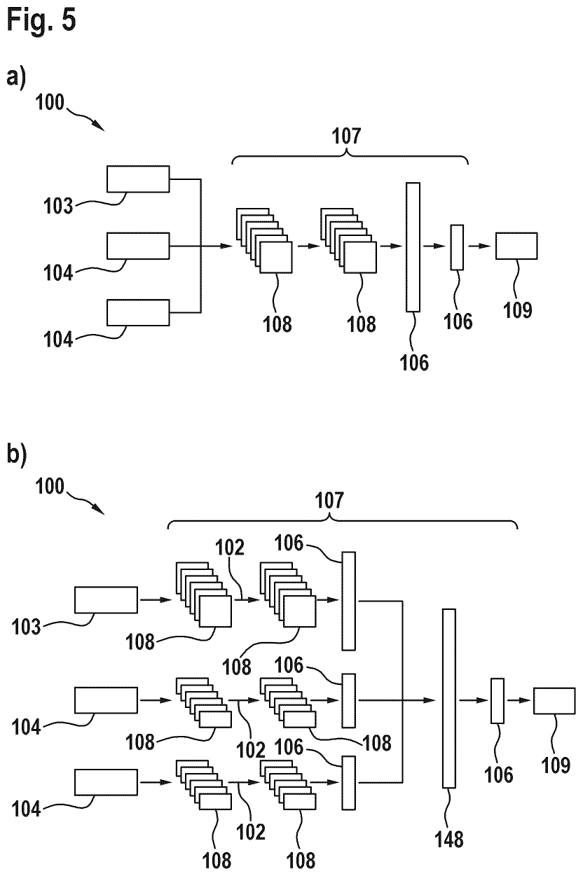

FIG. 5 shows a further schematic representation of the measuring device 100 according to a further embodiment.

Graphs a) and b) of FIG. 5 show two different alternatives of joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107 based on this.

On the other hand, in graph b) the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnostics of the different processing paths 102 are combined and fed to a final dense layer 106. The output data of the diagnostic module 107 corresponds to the diagnostic results 109 described above.

The correspondingly configured diagnostic module 107 is configured to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from the prior art.

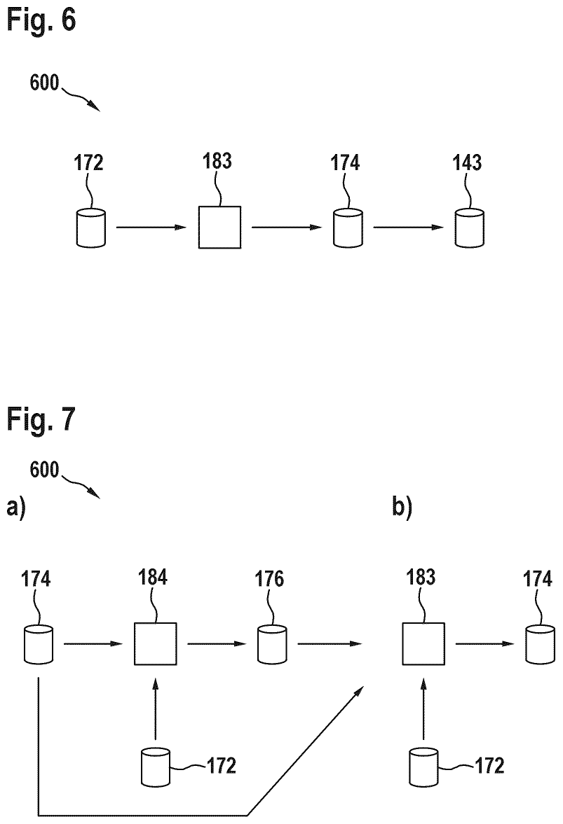

FIG. 6 shows a schematic representation of a system 600 for generating a training dataset 143 according to one embodiment.

In the embodiment shown, the system 600 for generating a training dataset 143 comprises classifier module 183. The classifier module 183 is configured as an artificial intelligence trained to generate classified sensor data 174 based on unclassified sensor data 172.

The unclassified sensor data 172 here depicts walls 105 to be examined and objects 113 disposed therein. The unclassified sensor data 172 may include radar data 103 or additional sensor information 104. The unclassified sensor data 172 may be based on a plurality of measurements of a plurality of measuring devices 100 of a plurality of different walls 105.

According to the disclosure, the classifier module 183 is trained via a semi-supervised learning process to determine a classification for unclassified sensor data in relation to the wall type 123 of the wall 105 and/or the object position 115 and/or the object type 117 of the object 113.

A corresponding training dataset 143 may subsequently be generated by the system 600 based on the sensor data 174 classified by the classifier module 183.

The classifier module 183 may be further trained to classify the unclassified sensor data 172 in addition to wall type 123, object position 115, and/or object type 117 with respect to the object depth 119 and/or object extent 121

FIG. 7 shows a further schematic representation of the system 600 for generating a training dataset 143 according to a further embodiment.

The embodiment in FIG. 7 is based on the embodiment in FIG. 6 and includes all the features described there.

Graphic a) illustrates a training process of the classifier module 183. On the other hand, graphic b) represents the actual application process of the classifier module 183 trained according to the training method of graphic a).

To train the classifier module 183, a training dataset is generated based on classified sensor data 174 and sensor data having a pseudo-classification 176. The classifier module 183 is subsequently trained based on the classified sensor data 174 and the sensor data with a pseudo-classification 176 to classify unclassified sensor data 172 and generate classified sensor data 174.

The sensor data with a pseudo-classification 176 is generated by a pseudo-classification module 184. The pseudo-classification module 184 is configured as a trained artificial intelligence trained to generate sensor data with a pseudo-classification 176 based on unclassified sensor data 172. The sensor data with a pseudo-classification 176 is to be understood here as classified sensor data generated by the pseudo-classification module 184.

The pseudo-classification module 184, in turn, has been trained on classified sensor data 174 to generate sensor data with a pseudo-classification 176 based on unclassified sensor data 172.

The classifier module 183 is subsequently classified based on the classified sensor data 174 and the sensor data generated by the pseudo-classification module 184 with a pseudo-classification 176.

The classified sensor data 174 of the graphic a) used for training the pseudo-classification module 184 and the classifier module 183 does not correspond to the classified sensor data 174 of the graphic b) generated by the trained classifier module 183 based on the unclassified sensor data 172. The classified sensor data 174 of the training shown in graphic a) are, on the other hand, manually classified sensor data that were classified in a classification process by an experimenter.

The unclassified sensor data 172 used during this in graphic a) to generate the sensor data with a pseudo-classification 176 also does not correspond to the unclassified sensor data 172 used during application of the trained classifier module 183 to generate the training dataset.

The unclassified sensor data 172 of the graphics a) and b) may be identical, but does not have to be.

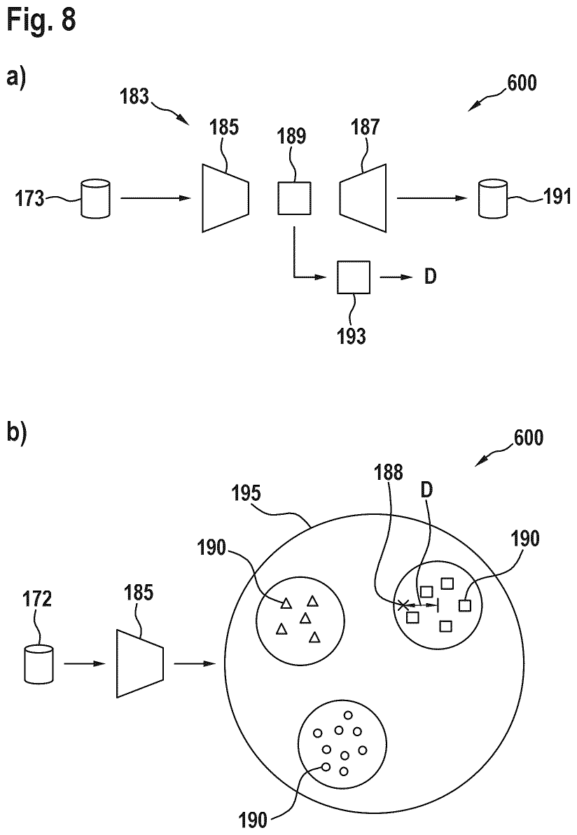

FIG. 8 shows a further schematic representation of the system 600 for generating a training dataset 143 according to a further embodiment.

In the embodiment shown, the classifier module 183 is configured as an autoencoder having an encoder module 185 and a decoder module 187. Via the encoder module, the classifier module 183 is configured to generate corresponding latent space representations 189 based on sensor data 173. The latent space representations 189 correspond to dimension-reduced representations of the sensor data 173. In the prior art of machine learning, such latent space representations are configured as vector representations. The sensor data 173 may include unclassified and/or classified sensor data 172, 174.

The decoder module 187, on the other hand, is configured to decode the information encoded in latent space representations 189 of the sensor data 173 and to generate sensor data 191 generated based on the latent space representations 189. Thus, new sensor data may be generated via the decoder module 187 based solely on latent space representations 189 and not generated by measurements of corresponding sensor units.

To classify unclassified sensor data 172 and generate classified sensor data 174, the classifier module 183 further comprises a distance determination module 193. Distances between the latent space representations 189 in latent space 195 can be determined via the distance determination module 193.

Graphic b) shows such classification of unclassified sensor data 172 via a distance determination of corresponding latent space representations in latent space 195.

First, the correspondingly trained encoder module 185 determines a corresponding latent space representation 188 of the unclassified sensor data 172 for the unclassified sensor data 172. In graphic b), three groups of latent space representations 190 of classified sensor data 174 are further depicted in the latent space 195. The latent space representations 190 are summarized into three groups spaced apart from each other. The latent space representations 190 of the three different groups each represent classified sensor data 174. The latent space representations 190 of a common group here represent sensor data of a common object class. To classify the unclassified sensor data 172, the distance determination module 193 subsequently determines distances D between the latent space representations 188 of the unclassified sensor data 172 and the latent space representations 190 of the classified sensor data 174. Now, if the determined distance D between the latent space representations 188 and the latent space representations 190 of the classified sensor data 174 is less than or equal to a predetermined threshold, then the respective unclassified sensor data 172 is assigned the respective classification of the classified sensor data 174 for which the distance D of the respective latent space representation 188 is less than or equal to the predetermined threshold.

Because the classifications of the classified sensor data 174 are already known, they may be incorporated into the respective latent space representations 190 as additional information. In this way, the distance determination may then be performed by the distance determination module 193 for the various latent space representations 188, 190 in the latent space 195, for example, by a Euclidean distance metric. Latent space representations 190 representing classified sensor data 174 of the same classification are spaced close together because they have the same classification information in latent space and are arranged in the groups shown in graphic B. Thus, the classification of the unclassified sensor data 172 can be carried out via the distance determination D.

Graphic b) shows such a classification. The latent space representation 188 of the unclassified sensor data 172 is spaced apart from the latent space representations 190 of the classified sensor data 174 shown in squares at a distance D that is less than the predefined threshold value. This is characterized in that the latent space representation 188, marked X, is disposed in the group of latent space representations 190, marked with square icons.

Latent space representations 188 which, on the other hand, have a greater distance D than the predefined threshold value to the latent space representations 190 of the classified sensor data 174 cannot be classified via the method shown. For example, such unclassified sensor data 172 may be disregarded for the training dataset 143 to be generated.

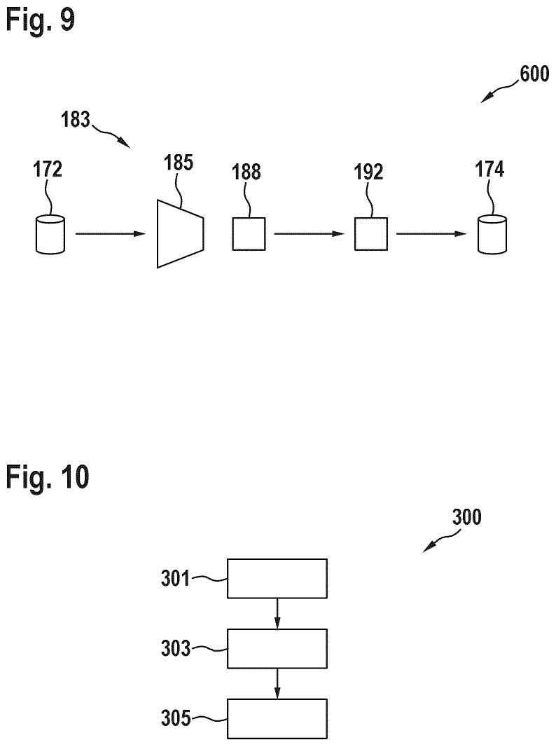

FIG. 9 shows a further schematic representation of the system 600 for generating a training dataset 143 according to a further embodiment.

The embodiment shown in FIG. 9 is based on the embodiment in FIG. 6 and includes all the features described there. In the embodiment shown, the classifier module 183 comprises an encoder module 185 trained according to the embodiment in FIG. 8. The encoder module 185 is configured to generate latent space representations 189 based on sensor data 173. The sensor data 173 may comprise unclassified and classified sensor data 172, 174. Further, the classifier module 183 includes a classification module 192.

Thus, to classify unclassified sensor data 172, the correspondingly trained encoder module 185 generates latent space representations 188 of the unclassified sensor data 172.

The classifier module 192 may generate correspondingly classified sensor data 174 based on the latent space representations 188 of the unclassified sensor data 172. The classifier module 192 is configured as an artificial intelligence and trained to predict the corresponding classification of the sensor data based on latent space representations 188 of unclassified sensor data. The classifier module 192 may have been trained on latent space representations 190 of classified sensor data 174 to predict corresponding classifications based on latent space representations 188 of unclassified sensor data 172.

FIG. 10 shows a flowchart of a method 300 for generating a training dataset 143 according to one embodiment.

To generate a training dataset, in a first method step 301, unclassified sensor data 172 of at least one sensor unit 101 of the measuring device 100 is first received by the classifier module 183.

In a further method step 303, the unclassified sensor data 172 is classified and classified sensor data 174 is provided by the classifier module 183. The classifier module 183 is configured as an artificial intelligence and trained via semi-supervised learning to determine a classification for unclassified sensor data 172 with respect to the wall type 123 of the wall 105 and/or the object position 115 and/or the object type 117 of the object 113.

In a further method step 305, the sensor data 174 classified in this manner is aggregated into a training dataset 143 or added to an already existing training dataset 143.

According to one embodiment, the classification may be carried out, in addition to the wall type 123, the object position 115, and/or object type 117, with respect to the object depth 119 and/or object extent 121.

FIG. 11 shows a further flowchart of the method 300 for generating a training dataset 143 according to a further embodiment.

The embodiment shown in FIG. 11 is based on the embodiment in FIG. 10 and comprises all the method steps described there.

In the embodiment shown, latent space representations 188 are generated by the classifier module 183 for the unclassified sensor data 172 for classification 303 in a method step 307.

In a further method step 309, distances D between the latent space representations 188 of the unclassified sensor data 172 and latent space representations 190 of classified sensor data 174 are determined by the distance determination module 193.

In a further method step 311, the unclassified sensor data 172 is classified with respect to the wall type 123 and/or the object position 115 and/or the object type 117 based on the distances D between the latent space representations 188 of the unclassified sensor data 172 and the latent space representations 190 of the classified sensor data 174. The unclassified sensor data 172 is classified according to a classification of the classified sensor data 174, if the distances D between the latent space representations 188 of the unclassified sensor data 172 and the latent space representations 190 of the classified sensor data 174 are less than or equal to a predefined threshold value.

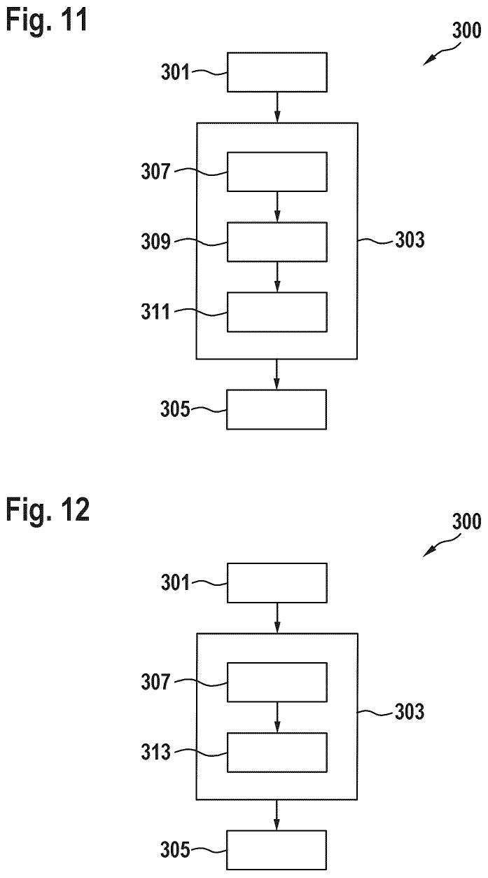

FIG. 12 shows a further flowchart of the method 300 for generating a training dataset 143 according to a further embodiment.

The embodiment in FIG. 12 is based on the embodiment in FIG. 10 and includes all the features described there.

In the embodiment shown, the latent space representations 188 of the unclassified sensor data 172 are generated to classify 303 the unclassified sensor data 172 in method step 307. In a further method step 313, the unclassified sensor data 172 is classified with respect to the wall type 123 and/or the object position 11 and/or the object type 117 based on the latent space representations 188 of the unclassified sensor data 172 by the classifier module 192. The classifier module 192 is configured as an artificial intelligence and is trained to determine corresponding classifications of the sensor data based on latent space representations 188 of unclassified sensor data 172.

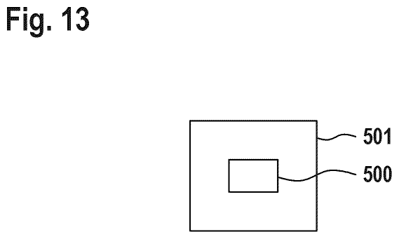

FIG. 13 shows a schematic representation of a computer program product 500 comprising instructions that, when the program is executed by a data processing unit, cause the latter to perform the method 300 for generating a training dataset 143.

In the embodiment shown, the computer program product 500 is stored on a storage medium 501. The storage medium 501 can in this case be any desired storage medium known from the prior art.

What is claimed is:

1. A computer-implemented method for generating a training dataset for training an artificial intelligence for operating a measuring device, comprising:
receiving unclassified sensor data of at least one sensor unit of a measuring device using a classifier module, wherein the unclassified sensor data depicts a wall to be diagnosed with a wall type, and wherein an object of an object type is disposed in the wall in an object position;
classifying the unclassified sensor data and providing classified sensor data using a classifier module, wherein the classifier module is configured as an artificial intelligence and trained via semi-supervised learning to determine a classification for unclassified sensor data with respect to the wall type of the wall and/or the object position and/or the object type of the object; and
adding the classified sensor data to a training dataset.

2. The method of claim 1, wherein the classifier module is trained based on classified sensor data and sensor data with pseudo-classifications to determine corresponding classifications for unclassified sensor data, wherein the pseudo-classifications were predicted by a pseudo-classification module based on unclassified sensor data, and wherein the pseudo-classification module is configured as an artificial intelligence and is trained based on classified sensor data to determine pseudo-classifications for unclassified sensor data.

3. The method of claim 1, wherein classification comprises:
generating latent space representations of the unclassified sensor data in a latent space using the classifier module, wherein latent space representations of unclassified or classified sensor data are formed as dimension-reduced representations of the sensor data;
determining distances between the latent space representations of the unclassified sensor data and latent space representations of classified sensor data in the latent space using a distance determination module; and
classifying the unclassified sensor data with respect to the wall type of the wall and/or the object position and/or the object type of the object based on the distances between the latent space representations of the unclassified sensor data and the latent space representations of the classified sensor data in the latent space, wherein the unclassified sensor data is classified according to a classification of the classified sensor data, if the distances between the latent space representations of the unclassified sensor data and the latent space representations of the classified sensor data in the latent space are less than or equal to a predefined threshold value.

4. The method of claim 1, wherein classification comprises:
generating latent space representations of the unclassified sensor data in a latent space using the classifier module, wherein latent space representations of unclassified or classified sensor data are formed as dimension-reduced representations of the sensor data; and
classifying the unclassified sensor data with respect to the wall type of the wall and/or the object position and/or the object type of the object based on the latent space representations of the unclassified sensor data using a classifier module, wherein the classifier module is configured as an artificial intelligence and is trained to determine a classification of the respective sensor data based on latent space representations of classified sensor data.

5. The method of claim 4, wherein the classifier module is configured as a Generative Adversarial Network.

6. The method of claim 1, wherein the sensor data comprises radar data of a radar sensor and/or data of an induction sensor and/or an eddy current sensor and/or a capacitance sensor and/or an alternating current sensor and/or an NMR sensor and/or an ultrasonic sensor.

7. The method of claim 1, wherein the classification of the sensor data is further performed in relation to an object depth and/or an object extension of the object.

8. The method of claim 1, wherein object classes of the object type of the object comprise: metallic/non-metallic object, low voltage cable, single phase AC signal cable, multiphase AC signal cable, wood beam, metal beam, plastic pipe, water filled plastic pipe, non-water filled plastic pipe, and/or wherein the wall type classes of the wall type of the wall comprise: concrete wall, plasterboard/drywall wall, brick wall and/or bricks of the wall, underfloor heating, wall heating.

9. A training dataset for training an artificial intelligence of a wall diagnostic measuring device, wherein the training dataset was generated according to the method for generating a training dataset according to claim 1.

10. A computing unit configured to perform the method of generating a training dataset for training an artificial intelligence for operating a measuring device of claim 1.

11. A computer program product comprising instructions which, when the program is executed by a data processing unit, prompt the data processing unit to perform the method for generating a training dataset for training an artificial intelligence to operate a measuring device according to claim 1.

12. The method of claim 1, wherein the measuring device is a wall diagnostic device.

13. The method of claim 4, wherein the classifier module is configured as an autoencoder having an encoder module and a decoder module.

14. The method of claim 8, wherein:
the water filled plastic pipe is a fresh water pipe, and
the non-water filled plastic pipe is a waste water pipe.
